(19) United States
(12) Patent Application Publication
(10) Pub. No.: US 2026/0116283 A1
(43) Pub. Date: Apr. 30, 2026

(54) FORMATION OF OUTER SHELL OF CARAVAN OR RV

(71) Applicant: Desertmaster Intellecutal Property PTY Ltd., Chester Hill (AU)

(72) Inventor: Peter Naylor, Chester Hill (AU)

(73) Assignee: Desertmaster Intellecutal Property PTY Ltd., Chester Hill (AU)

(21) Appl. No.: 19/357,223

(22) Filed: Oct. 14, 2025

(30) Foreign Application Priority Data
Oct. 25, 2024 (AU) 2024903476
Oct. 3, 2025 (AU) 2025242238

(51) Int. Cl. B60P 3/32; B62D 29/00

(52) U.S. Cl. CPC B60P 3/32; B62D 29/001

(57) ABSTRACT

A caravan or RV has at least a roof and a front and/or rear wall formed from a single panel. The panel is bent at a bend formed by kerfing on an internal face of the panel. The shell of the caravan or RV may be formed by a single panel which is bent into position and sealed at the resulting joints.

### PRIORITY INFORMATION

Pursuant to 35 U.S.C. § 119 (a), this application claims the benefit of earlier filing date and right of priority to Australia Patent Application Number AU 2024903476, filed on Oct. 25, 2024. The entire content of Spanish Patent Application Number AU 2024903476, filed on Oct. 25, 2024, is hereby incorporated by reference.

Pursuant to 35 U.S.C. § 119 (a), this application claims the benefit of earlier filing date and right of priority to Australia Patent Application Number AU 2025242238, filed on Oct. 3, 2025. The entire content of Spanish Patent Application Number AU 2025242238, filed on Oct. 3, 2025, is hereby incorporated by reference.

### BACKGROUND

The present invention relates to the manufacture of caravans and recreational vehicles (RVs).

The caravan and motorhome industry are challenged with designing and fabricating structures that offer adequate strength, reasonable manufacturing cost, are light weight, and, in particular, are resistant to water ingress. The issue of water ingress into the shell of a caravan or RV is a longstanding problem in the industry.

A typical caravan or RV—a “house on wheels”—often consists of six or more separate panels which make up a shell. Such a shell must then be able to be driven or towed at 60 mph in the rain while being shaken on a bumpy road. It must be able to do this while avoiding any leaks.

The issue of unwanted water ingress accounts for the most serious quality issues in the industry, and accounts for a large portion of customer dissatisfaction events.

Due to the materials commonly used in fabrication, and the common methods of fabrication, the manufacturing process of an RV product's shell is highly reliant on the well-developed tool skill of the assemblers, and similarly reliant on well-developed quality assurance programmes. Even with skilled assemblers and quality systems the produced shell can be easily constructed out of square and out of plumb.

These issues result in panel joining accounting for a significant proportion of the costs in caravan fabrication, especially when considering the costs of future maintenance and possible warranty claims.

Modern caravans or RVs are generally fabricated from laminated panels. These panels combine an outside skin, an inside skin, and a core material between the skins. The panels are generally framed, at least at the edges. Such a laminated framed panel offers a strong, light weight, thermally efficient, and workable structure that can then be combined with similar panels to make up a shell of an RV.

The most common materials used as a skin are fiberglass and aluminium foil. Framing is usually wooden or aluminium, although other materials have in recent times been used. The core is generally a ridged foam material, or a honeycomb. The skins and core are generally glued and pressed together.

The laminated panels are generally combined at joints using screws and glue. The addition of corner cover strips may offer some additional strength, an aesthetic feature, and weather proofing.

Each panel is typically fixed to adjoining panels along each of four edges. In a basic structure, this means that there are 12 joints which must remain watertight along their full lengths. It is common to form a roof from two panels, meaning there is likely to be a total of 15 joints.

It will be understood by a skilled reader that the above description does not cover all RV manufacturing. In fact, in many countries the industry is dominated by a combination of wooden framing (plywood or wooden stick framing) that is then covered with aluminium sheets, and the internal skin is most often 3 mm ply. This system is particularly vulnerable to water ingress with deleterious results.

According to one aspect of the present invention there is provided a panel forming part of a caravan or RV, the caravan or RV having at least six faces comprising three sets of two opposed faces, each of the three sets of faces being oriented generally in a respective one of three perpendicular directions, the panel having at least one bend formed therein such that the panel forms at least two of the faces.

In a preferred embodiment, the panel forms a roof of the caravan or RV along with at least one of a front wall and a rear wall of the caravan or RV.

It is preferred that the panel forms the roof and both the front wall and rear wall of the caravan or RV.

The front wall and/or the rear wall may have two faces which are angled with respect to each other.

The panel may additionally form a floor of the caravan or RV.

The panel may additionally form at least a portion of one or two side walls of the caravan or RV.

The panel may be formed from an outer skin, an inner skin, and a core material.

The panel may be framed at its edges.

The bend(s) may be formed by kerfing through the inner skin and core material.

Alternatively, the bend(s) may be formed by moulding the panel in a configuration incorporating the bend(s).

### BRIEF DESCRIPTION OF THE DRAWINGS

It will be convenient to further describe the invention with reference to preferred embodiments of the present invention. Other embodiments are possible, and consequently the particularity of the following discussion is not to be understood as superseding the generality of the preceding description of the invention. In the drawings:

FIG. 1 is a panel in accordance with a first embodiment of the present invention; shown in a flat state;

FIG. 2 is the panel of FIG. 1, shown during initial bending;

FIG. 3 is the panel of FIG. 1, shown during a second bending stage;

FIG. 4 is the panel of FIG. 1, shown during a third bending stage;

FIG. 5 is the panel of FIG. 1, shown during a fourth bending stage;

FIG. 6 is the panel of FIG. 1, shown after completion of bending;

FIG. 7 is a caravan formed using the panel of FIG. 1, shown during the addition of side walls;

FIG. 8 is the caravan of FIG. 5, shown after the addition of side walls;

FIG. 9 is a panel in accordance with a second embodiment of the present invention, shown during initial bending; and

FIGS. 10 to 14 are the panel of FIG. 9, shown during further bending.

### DETAILED DESCRIPTION OF THE DRAWINGS

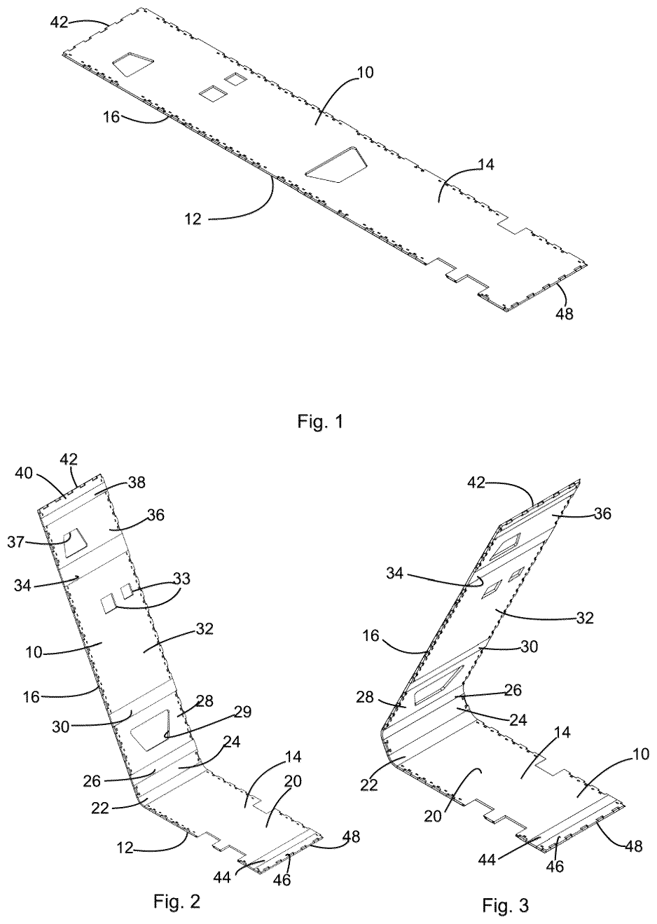

Referring to the Figures, FIG. 1 shows a panel 10 having an outer skin 12, an inner skin 14 and a core (not shown). In a preferred embodiment the outer skin 12 and inner skin 14 are formed from aluminum with the core being formed from a rigid polymer foam. Other possible constructions will be apparent to a skilled addressee. The panel 10 has a frame 16 which encloses the core along an edge of the panel 10.

As can be seen more readily in FIG. 2, the panel 10 has a first portion 20 arranged, in use, to form a floor of a caravan; a first bend 22; a second portion 24 arranged, in use, to form a lower part of a front wall of the caravan; a second bend 26; a third portion 28 arranged, in use, to form an upper part of the front wall of the caravan, the third portion 28 including a front window 29; a third bend 30; a fourth portion 32 arranged, in use, to form a roof of the caravan and including skylights 33; a fourth bend 34; a fifth portion 36 arranged, in use, to form an upper part of a rear wall of the caravan and including a rear window 37; a fifth bend 38; a sixth portion 40 arranged, in use, to form part of the rear wall of the caravan, the sixth portion 40 having an exposed edge 42 sealed by the frame 16; a sixth bend 44 located next to the first portion 20; and a seventh portion 46 arranged, in use, to form part of the rear wall of the caravan, the seventh portion 46 having an exposed edge 48 sealed by the frame 16.

Each of the bends 22, 26, 30, 34, 38, 44 are formed by kerfing through the inner skin 14 and the core. It will be appreciated that each of the bends 22, 26, 30, 34, 38, 44 have a longitudinal extent when shown in the unbent position of FIG. 1. Once bent, this longitudinal extent corresponds to an outer arc length of the respective bend 22, 26, 30, 34, 38, 44.

FIG. 2 shows the panel 10 with the first bend 22 bent such that the first portion 20 and the second portion 24 form an angle of 117°. In the embodiment shown the first bend 22 has a radius of curvature of 300 mm.

FIG. 3 shows the panel 10 with the second bend 26 bent though a radius of curvature of 300 mm such that the second portion 24 and the third portion 28 form an angle of 126°.

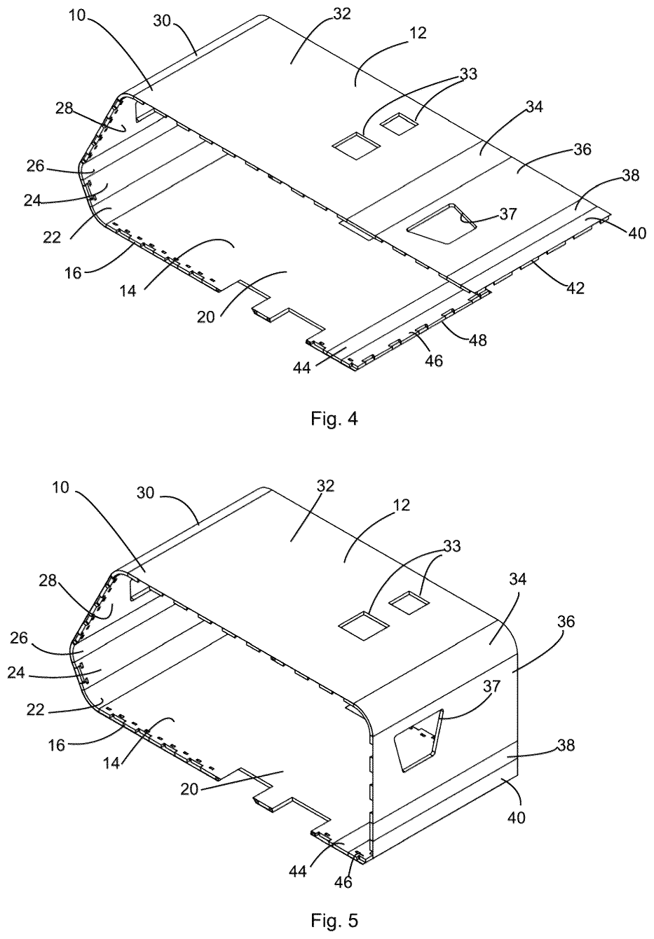

FIG. 4 shows the panel 10 with the third bend 30 bent such that the third portion 28 and the fourth portion 32 form an angle of 117°. The third bend 30 has a radius of curvature of 300 mm. It will be appreciated that the fourth portion 32 is now parallel to the first portion 20.

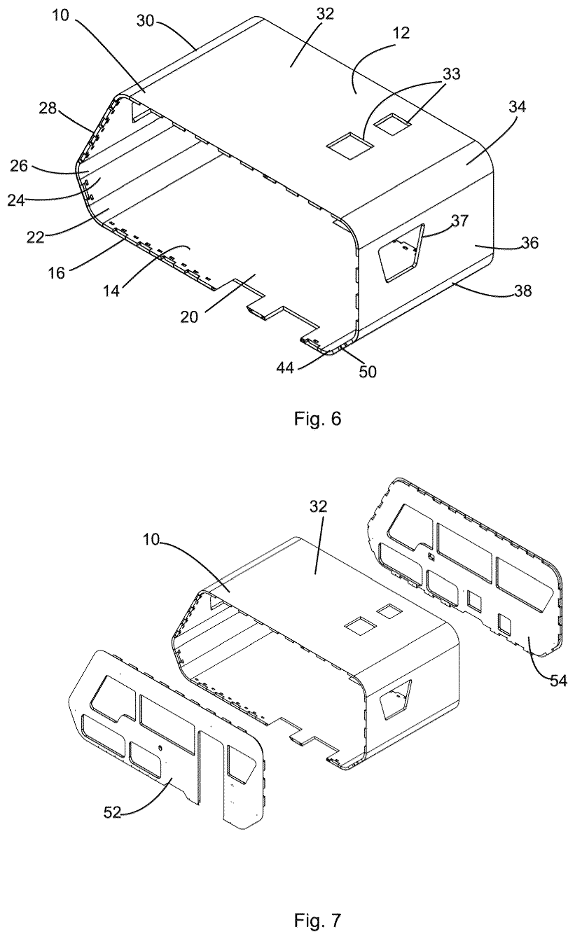

FIG. 5 shows the panel 10 with the fourth bend 34 bent such that the fourth portion 32 and the fifth portion 36 form an angle of 90°.

FIG. 6 shows the panel 10 with the fifth bend 38 bent such that the fifth portion 36 and the sixth portion 40 form an angle of 135°, and the sixth bend 44 bent such that the first portion 20 and the seventh portion 46 form an angle of 135°. It will be appreciated that the exposed edges 42, 48 abut each other when in the position of FIG. 6, and can be bonded together by suitable means.

In the embodiment of the drawings, the exposed edge 42 of the sixth portion 40 has protrusions along its length, and the exposed edge 48 of the seventh portion 46 has complementary recesses. The slotting of the protrusions into the recesses may assist in bonding of the edges to each other.

The exposed edges 42, 48 are bonded along a join 50. The join 50 is the only join used in creating the caravan shell of FIG. 6. The join 50 is in a sheltered lower portion of a rear wall of the caravan.

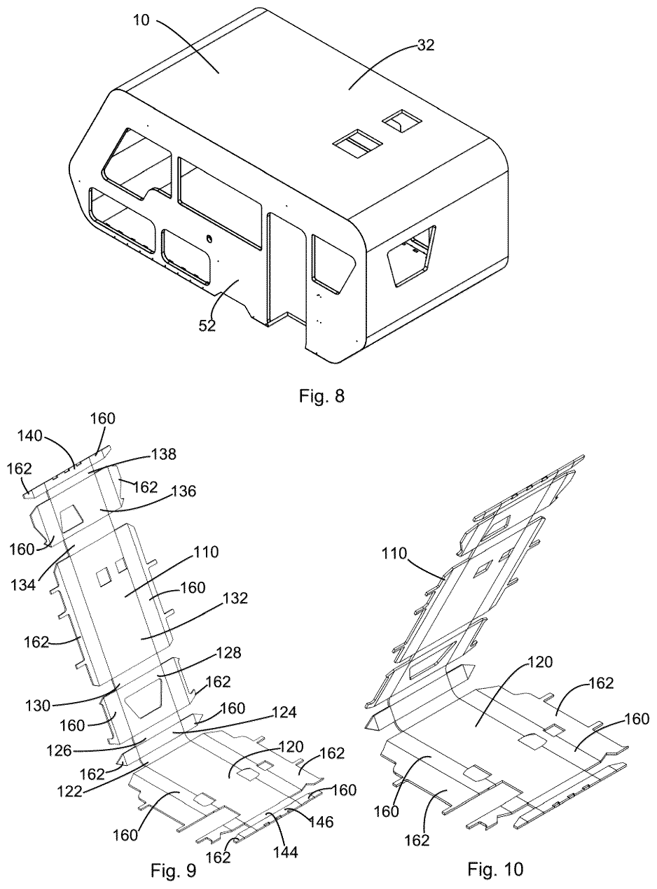

First and second side walls 52, 54 can be affixed to the caravan shell of FIG. 6 by known means. This is shown in FIGS. 7 and 8.

It will be appreciated that the caravan thus formed has eight faces: a floor opposed to a roof; a first side wall 52 opposed to a second side wall 54; and a front wall having a lower part and an upper part opposed to a rear wall having a lower part and an upper part.

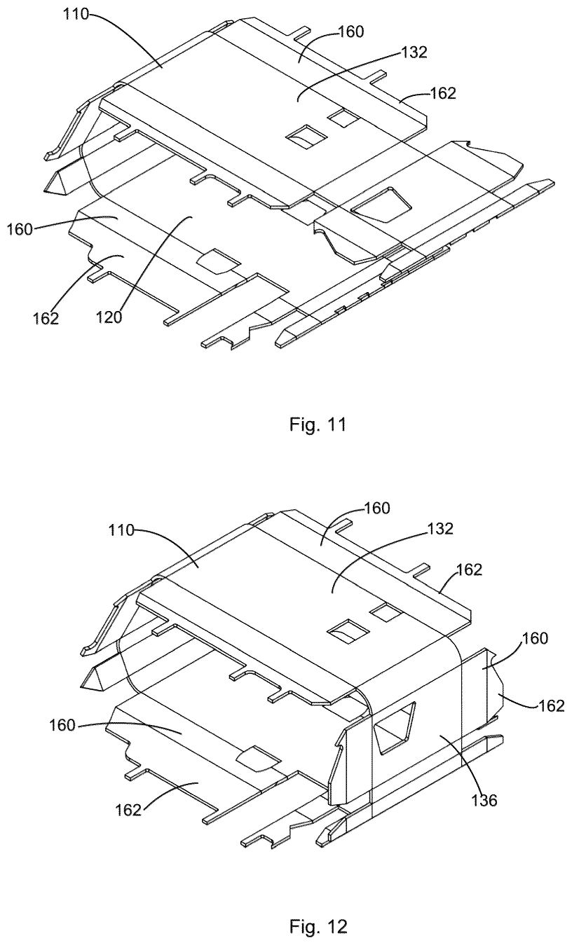

FIGS. 9-12 show an alternative embodiment of the present invention, being a panel 110. As illustrated in FIGS. 9-12, the panel 110 has first to seventh portions 120, 124, 128, 132, 136, 140, 146 corresponding to the first to seventh portions 20, 24, 28, 32, 36, 40, 46.

The panel 110 has first to sixth bends 122, 126, 130, 134, 138, 144 corresponding to the first to sixth bends 22, 26, 30, 34, 38, 44 of the panel 10, as illustrated in FIGS. 9-12.

Each of the panel portions 120, 124, 128, 132, 136, 140, 146 has an associated side bend 160 and side portion 162 on each lateral side of the panel portion 120, 124, 128, 132, 136, 140, 146, as illustrated in FIGS. 9-12. The side bends 160 and side portions 162 represent lateral extensions away from the panel portions 120, 124, 128, 132, 136, 140, 146, as illustrated in FIGS. 9-12.

The arrangement is such that when the panel 110 has been bent to form the caravan shell, as shown in FIG. 13, each of the side bends 160 can be bent through 90°.

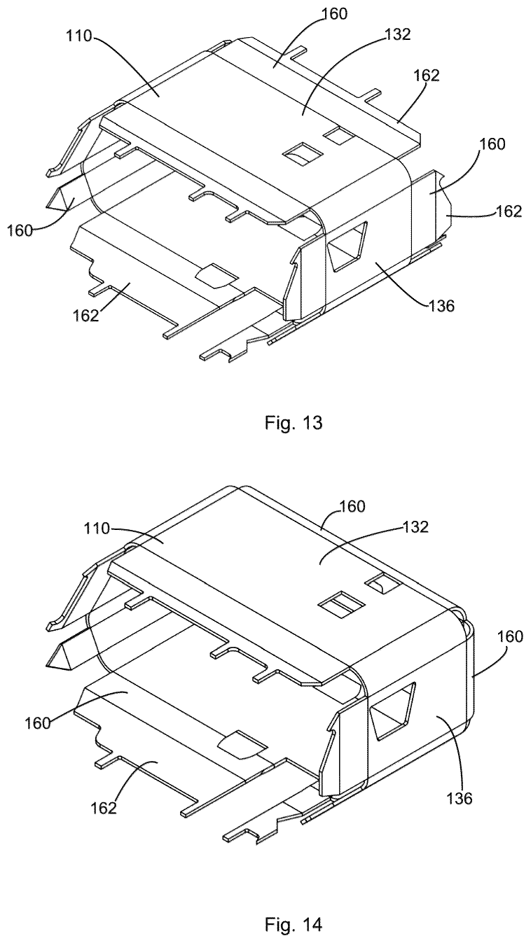

The side portions 162 are sized and shaped such that when the side bends 160° are bent through 90° each edge of a side portion 162 meets with an edge of another side portion 162. When all side bends 160 are bent through 90° the side portions 162 combine to form side walls 152, 154 of the caravan. This is shown in FIG. 14.

It will be appreciated that joins 164 will be required along meeting lines of the side portions 162. These joins 164 will be within the side walls 152, 154, and are considered unlikely to represent a serious leakage risk.

Modifications and variations as would be apparent to a skilled addressee are deemed to be within the scope of the present invention.

What is claimed is:

1. A panel forming part of a caravan or RV, the caravan or RV having at least six faces comprising:
three sets of two opposed faces, each of the three sets of faces being oriented generally in a respective one of three perpendicular directions; and
at least one bend formed in the panel such that the panel forms at least two of the faces.

2. The panel as claimed in claim 1, wherein the panel forms a roof of the caravan or RV along with at least one of a front wall and a rear wall of the caravan or RV.

3. The panel as claimed in claim 1, wherein the panel forms the roof and both the front wall and rear wall of the caravan or RV.

4. The panel as claimed in claim 2, wherein the front wall and/or the rear wall has two faces which are angled with respect to each other.

5. The panel as claimed in claim 2, wherein the panel additionally forms a floor of the caravan or RV.

6. The panel as claimed in claim 2, wherein the panel additionally forms at least a portion of one or two side walls of the caravan or RV.

7. The panel as claimed in claim 2, wherein the panel is formed from an outer skin, an inner skin, and a core material.

8. The panel as claimed in claim 7, wherein the bend(s) are formed by kerfing through the inner skin and core material.

9. The panel as claimed in claim 1, wherein the bend(s) are formed by moulding the panel in a configuration incorporating the bend(s).

10. The panel as claimed in claim 1, wherein the panel is framed at its edges.
